(19) United States
(12) Patent Application Publication
(10) Pub. No.: US 2026/0167161 A1
(43) Pub. Date: Jun. 18, 2026

(54) APPARATUS FOR CONTROLLING BRAKING OF AUTONOMOUS VEHICLE AND METHOD THEREOF

(71) Applicants: Hyundai Motor Company, Seoul (KR); Kia Corporation, Seoul (KR)

(72) Inventor: Hyung Mook KIM, Hwaseong-Si (KR)

(21) Appl. No.: 19/203,756

(22) Filed: May 9, 2025

(30) Foreign Application Priority Data
Dec. 18, 2024 (KR) 10-2024-0189470

(51) Int. Cl. B60T 8/17; B60T 7/12; B60T 13/68

(52) U.S. Cl. CPC B60T 8/17; B60T 7/12; B60T 13/683; B60T 2270/402; B60T 2270/403; B60T 2270/406; B60T 2270/414

(57) ABSTRACT

An apparatus for controlling autonomous driving of a vehicle includes a processor and a memory storing at least one instruction. When executed by the processor communicating with the memory, the instruction causes the apparatus to control, using a first control circuit of the vehicle, a first brake system of the vehicle, control, using a second control circuit of the vehicle, a second brake system of the vehicle, determine a state of the first control circuit and a state of the second control circuit, output, based on the determined states, a signal indicating transfer of braking control authority from the first control circuit to the second control circuit, and transfer the braking control authority based on the signal.

### CROSS-REFERENCE TO RELATED APPLICATION

This application claims the benefit of priority to Korean Patent Application No. 10-2024-0189470, filed in the Korean Intellectual Property Office on Dec. 18, 2024, the entire contents of which are incorporated herein by reference.

### TECHNICAL FIELD

The present disclosure relates to a transition strategy between a main brake system and a redundancy brake system provided in an autonomous vehicle.

### BACKGROUND

The matters described in this Background section are only for enhancement of understanding of the background of the disclosure, and should not be taken as acknowledgment that they correspond to prior art already known to those skilled in the art.

An autonomous vehicle may refer to a vehicle that monitors external information, understands the driving situation, and drives autonomously to a set destination without driver intervention. While the autonomous vehicle drives, the autonomous driving mode and the driver mode may be switched back and forth. The mode switch may occur at a time point if driving control authority is transferred.

For example, when a serious malfunction occurs in the brake itself or the brake controller, it may be dangerous for the vehicle to continue to drive autonomously without a clear judgment of the driving situation, so the autonomous driving system of the vehicle may generate an alarm and request the driver to transfer driving control authority.

As described above, even if the autonomous driving system of the vehicle requests the driver to transfer driving control authority, there may be instances where the driver does not respond or is unable to respond immediately. In such cases, because the autonomous driving system is responsible for the safety of the vehicle before the complete transfer of driving control authority, the autonomous driving system of the vehicle may perform a minimum risk maneuver (MRM) that may apply different deceleration patterns depending on the driving environment of the vehicle. These minimum risk maneuver (MRM) may be able to decelerate the vehicle within an appropriate path.

Autonomous vehicles (e.g. autonomous trucks), may be provided with a dual brake system including a main brake system and a redundancy brake system. Such a dual brake system may have potential vulnerabilities because the dual brake system may have a main brake system and a redundancy brake system produced by a single manufacturer. In addition, because braking may be performed through internal communication between a main electronic control unit (ECU), which performs overall control of the main brake system and a redundancy ECU, which performs overall control of the redundancy brake system, the transition between the main brake system and the redundancy brake system may not occur smoothly or seamlessly.

### SUMMARY

The present disclosure has been made to solve the above-mentioned problems.

According to the present disclosure, an apparatus for controlling autonomous driving of a vehicle, the apparatus comprising a processor, and a memory storing at least one instruction that, when executed by the processor communicating with the memory, is configured to cause the apparatus to control, using a first control circuit of the vehicle, a first brake system of the vehicle, control, using a second control circuit of the vehicle, a second brake system of the vehicle, determine a state of the first control circuit and a state of the second control circuit, output, based on the determined state of the first control circuit and the determined state of the second control circuit, a signal indicating transfer of braking control authority of the autonomous driving of the vehicle from the first control circuit to the second control circuit, and transfer, based on the signal, the braking control authority from the first control circuit to the second control circuit.

The apparatus, wherein the at least one instruction, when executed by the processor communicating with the memory, is configured to cause the apparatus to perform, based on a failure occurring in the second control circuit, a minimum risk maneuver (MRM) associated with autonomous driving of the vehicle, wherein different deceleration patterns are applied, via the performance of the MRM, based on a driving environment of the vehicle.

The apparatus, wherein the at least one instruction, when executed by the processor communicating with the memory, is configured to cause the apparatus to control, using the second control circuit and based on a periodic standby command of the apparatus being interrupted, braking operation of the autonomous driving of the vehicle.

The apparatus, wherein the at least one instruction, when executed by the processor communicating with the memory, is configured to cause the apparatus to control, using the second control circuit and based on a message indicating a fault code being output by the apparatus, braking operation of the autonomous driving of the vehicle.

The apparatus, wherein the at least one instruction, when executed by the processor communicating with the memory, is configured to cause the apparatus to determine, based on power supplied to the first control circuit being interrupted, that a failure occurs in the first control circuit.

The apparatus, wherein the at least one instruction, when executed by the processor communicating with the memory, is configured to cause the apparatus to determine, based on vehicle network communication with the first control circuit being interrupted, that a failure occurs in the first control circuit.

The apparatus, wherein the at least one instruction, when executed by the processor communicating with the memory, is configured to cause the apparatus to determine, based on power supplied to the second control circuit being interrupted, that a failure occurs in the second control circuit, and wherein the first control circuit is comprised in a first electronic control unit (ECU).

The apparatus, wherein the at least one instruction, when executed by the processor communicating with the memory, is configured to cause the apparatus to determine, based on vehicle network communication with the second control circuit being interrupted, that a failure occurs in the second control circuit, wherein the second control circuit is comprised in a second electronic control unit (ECU).

The apparatus, wherein the first brake system comprises a first pneumatic control valve (PCV) configured to control an amount of air supplied to a right front wheel of the vehicle, a second PCV configured to control an amount of air supplied to a left front wheel of the vehicle, a front axle PCV configured to distribute an amount of air between the first PCV and the second PCV, and a rear axle PCV configured to distribute an amount of air between a right rear wheel and a left rear wheel of the vehicle.

The apparatus, wherein the second brake system comprises a first pneumatic control valve (PCV) configured to control an amount of air supplied to a right front wheel of the vehicle, a second PCV configured to control an amount of air supplied to a left front wheel of the vehicle, and a rear axle PCV configured to distribute an amount of air between a right rear wheel and a left rear wheel of the vehicle.

According to the present disclosure, a method performed by an apparatus for controlling autonomous driving of a vehicle, the method comprising determining a state of a first control circuit of the vehicle and a state of a second control circuit of the vehicle, wherein the first control circuit controls a first brake system of the vehicle, and wherein the second control circuit controls a second brake system of the vehicle, outputting, based on the determined state of the first control circuit and the determined state of the second control circuit, a signal indicating transfer of braking control authority of the autonomous driving of the vehicle from the first control circuit to the second control circuit, and transferring, based on the signal, the braking control authority from the first control circuit to the second control circuit.

The method, further comprising performing, based on a failure occurring in the second control circuit, a minimum risk maneuver (MRM) associated with autonomous driving of the vehicle, wherein different deceleration patterns are applied, via the performance of the MRM, based on a driving environment of the vehicle.

The method, further comprising controlling, using the second control circuit and based on a periodic standby command of the apparatus being interrupted, braking operation of the autonomous driving of the vehicle.

The method, further comprising controlling, using the second control circuit and based on a message indicating a fault code being output by the apparatus, braking operation of the autonomous driving of the vehicle.

The method, wherein the transferring of the braking control authority comprises determining, based on power supplied to the first control circuit being interrupted, that a failure occurs in the first control circuit.

The method, wherein the transferring of the braking control authority comprises determining, based on vehicle network communication with the first control circuit being interrupted, that a failure occurs in the first control circuit.

The method, wherein the performing of the MRM comprises determining, based on power supplied to the second control circuit being interrupted, that a failure occurs in the second control circuit.

The method, wherein the performing of the MRM comprises determining, based on network communication with the second control circuit being interrupted, that a failure occurs in the second control circuit.

According to the present disclosure, an apparatus of a vehicle, the apparatus comprising a processor, and a memory storing at least one instruction that, when executed by the processor communicating with the memory, is configured to cause the apparatus to determine, based on a first state of a first brake control circuit of the vehicle and a second state of a second brake control circuit of the vehicle, that a failure has occurred in the first brake control circuit and a failure has not occurred in the second brake control circuit, output, based on the determination, a signal indicating transferring braking control authority from the first brake control circuit to the second brake control circuit, and control, based on the signal and using the second brake control circuit, autonomous driving of the vehicle.

The apparatus, wherein the first brake control circuit is configured to control a first break system of the vehicle, the second brake control circuit is configured to control a second break system of the vehicle, and the first break system and the second break system have different braking systems.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a braking system of an autonomous vehicle according to an example of the present disclosure;

FIG. 2 shows an example of a configuration of an apparatus for controlling braking of an autonomous vehicle according to an example of the present disclosure;

FIG. 3 shows an example of a method of controlling braking of an autonomous vehicle according to an example of the present disclosure;

FIG. 4 shows a first detailed example of a method of controlling braking of an autonomous vehicle according to an example of the present disclosure;

FIG. 5 shows a second detailed example of a method of controlling braking of an autonomous vehicle according to an example of the present disclosure; and

FIG. 6 shows an exemplary computing system for executing a method of controlling braking of an autonomous vehicle according to each example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral even when they are displayed on other drawings. Further, in describing the example of the present disclosure, a detailed description of the related known configuration or function will be omitted when it is determined that it interferes with the understanding of the example of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In addition, autonomous driving may have different levels depending on conditions. For example, the levels classified by the Society of Automotive Engineers (SAE International) are commonly used, and are divided into six levels from ‘Level 0’ to ‘Level 5’.

Level 0 requires the driver to take full control of the vehicle, while Level 1 allows the vehicle's systems to perform lane keeping assist, smart cruise control, and other functions, such as steering or deceleration or acceleration, in specific driving modes. Highway driving assist, where the vehicle's system performs both steering and deceleration or acceleration in a specific driving mode, corresponds to Level 2. At Level 3, the vehicle's systems take over driving in a specific mode, such as highway driving pilot (HDP). The vehicle may change lanes on its own, overtake the vehicle in front, or avoid obstacles. Level 4 is the same as Level 3 in that the vehicle's system performs all driving, but may also respond safely in dangerous situations. Furthermore, Level 4 has restrictions on the area in which it may drive, while Level 5 has no restrictions.

At Level 3, when a situation arises where the vehicle's autonomous driving system continues to operate and becomes dangerous, measures must be prepared to anticipate and appropriately respond to such a situation. For example, if the autonomous driving of a vehicle becomes incapable, the autonomous driving system may generate a request to the driver to take back driving control authority, but the driver may not respond or may not respond immediately.

In this case, the autonomous driving system of the vehicle may perform minimum risk maneuver based on the driving environment of the vehicle to protect the driver and the vehicle and prevent accidents with surrounding vehicles, and may perform subsequent safety securing functions accordingly. In response to minimum risk maneuver, the vehicle's autonomous driving system must be able to slow down and stop the vehicle within an appropriate path.

Specifically, an automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., features of controlling dual braking systems) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of controlling dual braking systems) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of controlling dual braking systems) described herein.

Minimum risk maneuver (MRM) operation(s) may also be controlled, for example, based on one or more features (e.g., features of controlling dual braking systems) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of controlling dual braking systems) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of controlling dual braking systems) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

In each example of the present disclosure, a controller area network (CAN) is used as an example for explanation, but any one of CAN, a controller area network with flexible data-rate (CAN FD), a local interconnect network (LIN), FlexRay, media oriented systems transport (MOST), and Ethernet may be used as a vehicle network.

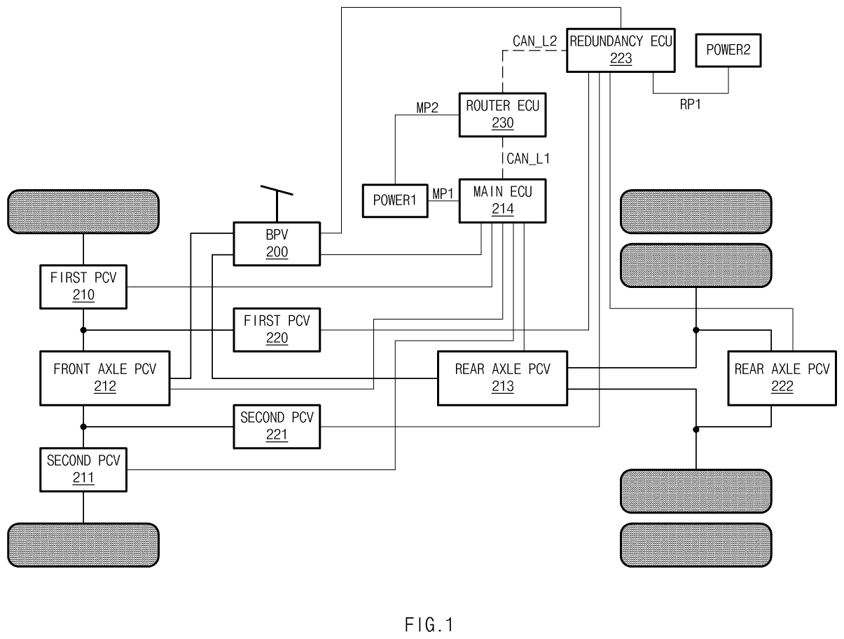

FIG. 1 shows an example of a configuration of a braking system of an autonomous vehicle according to an example of the present disclosure.

As shown in FIG. 1, a braking system of an autonomous vehicle according to an example of the present disclosure may include a main brake system (e.g., a brake system used during normal operation) (i.e., a first brake system) and a redundancy brake system (e.g., a backup brake system activated upon failure of the main brake system) (i.e., a second brake system).

First, the main brake system may include a brake pedal valve (BPV) 200, a first pneumatic control valve (PCV) 210, a second PCV 211, a front axle PCV 212, a rear axle PCV 213, and a main ECU 214. Here, the main ECU 214 refers to a first ECU.

The first PCV 210 may adjust the amount of air supplied to the pneumatic brake provided on the right front wheel of the autonomous vehicle, and the second PCV 211 may adjust the amount of air supplied to the pneumatic brake provided on the left front wheel of the autonomous vehicle (e.g., during lane changes, emergency braking, or deceleration scenarios).

The front axle PCV 212 may distribute the amount of air between the first PCV 210 and the second PCV 211, and the rear axle PCV 213 may distribute the amount of air between the pneumatic brake provided on the right rear wheel of the autonomous vehicle and the pneumatic brake provided on the left rear wheel (e.g., to maintain braking balance, ensure directional stability, or support adaptive braking algorithms).

The main ECU 214, which is a module that performs overall control of the main brake system, may receive main power (POWER 1), detect a user-requested braking amount through the BPV 200, and control the first PCV 210, the second PCV 211, the front axle PCV 212, and the rear axle PCV 213 based on the user-requested braking amount (e.g., based on pedal depression, deceleration commands from autonomous driving software, or emergency override signals).

The main ECU 214 may be activated or deactivated under the control of a router ECU 230, which is an upper level controller. For example, if power supplied to the main ECU 214 is interrupted, or if CAN communication with the main ECU 214 is interrupted, the router ECU 230 may deactivate the main ECU 214 (e.g., to prevent unsafe braking behaviors or to initiate transition to the redundancy brake system).

Next, the redundancy brake system may include a first PCV 220, a second PCV 221, a rear axle PCV 222, and a redundancy ECU 223. Here, the redundancy ECU 223 refers to a second ECU that may take over braking control if the main ECU is non-operational (e.g., due to power failure, communication loss, or fault detection by the router ECU).

The first PCV 220 may adjust the amount of air supplied to the pneumatic brake provided on the right front wheel of the autonomous vehicle, and the second PCV 221 may adjust the amount of air supplied to the pneumatic brake provided on the left front wheel of the autonomous vehicle (e.g., during autonomous lane keeping, curve handling, or emergency braking).

The rear axle PCV 222 may distribute the amount of air between the pneumatic brake provided on the right rear wheel of the autonomous vehicle and the pneumatic brake provided on the left rear wheel (e.g., to balance rear braking force, ensure vehicle stability, or assist trailer braking integration in autonomous trucks).

The redundancy ECU 223, which is a module that performs overall control of the redundancy brake system, may receive redundancy power (POWER 2), detect a user-requested braking amount through the BPV 200, and control the first PCV 220, the second PCV 221, and the rear axle PCV 222 based on the user-requested braking amount (e.g., determined by a backup autonomous driving controller, minimal risk maneuver command, or emergency fallback logic, etc.).

The redundancy ECU 223 may be activated or deactivated under the control of the router ECU 230 which is an upper level controller. For example, if power supplied to the redundancy ECU 223 is interrupted, or if CAN communication with the redundancy ECU 223 is interrupted, the router ECU 230 may deactivate the redundancy ECU 223 (e.g., to prevent conflicting brake control, to initiate MRM, or to maintain system integrity, etc.).

Meanwhile, the router ECU 230 refers to a controller 20 provided in an apparatus for controlling braking of an autonomous vehicle according to an example of the present disclosure, and may perform the following operations (e.g., failure detection, communication routing, or control authority transition, etc.).

The router ECU 230 may monitor the state of the main ECU 214 and the state of the redundancy ECU 223, and if a failure occurs in the main ECU 214, may transfer the braking control authority of the autonomous vehicle from the main ECU 214 to the redundancy ECU 223. In this case, the router ECU 230 may determine that a failure occurs in the main ECU 214 if the power supplied to the main ECU 214 is interrupted or if the CAN communication with the main ECU 214 is interrupted (e.g., due to a hardware malfunction, signal timeout, or CAN bus isolation, etc.).

The router ECU 230 may monitor the state of the main ECU 214 and the state of the redundancy ECU 223, and if a failure occurs in the redundancy ECU 223, may maintain the braking control authority of the autonomous vehicle held by the main ECU 214, and perform a minimum risk maneuver (MRM) that applies a different deceleration pattern depending on the driving environment of the autonomous vehicle (e.g., road grade, traffic density, or obstacle proximity). In this case, the router ECU 230 may determine that a failure occurs in the redundancy ECU 223 if the power supplied to the redundancy ECU 223 is interrupted or if the CAN communication with the redundancy ECU 223 is interrupted (e.g., due to power line disconnection, bus error, or message timeout).

The router ECU 230 may transmit vehicle information collected periodically through CAN to the main ECU 214, and if the vehicle information received from the router ECU 230 is interrupted (i.e., if a failure occurs in the router ECU 230), the main ECU 214 may not perform normal braking of the autonomous vehicle and may be automatically deactivated (e.g., to prevent braking misbehavior due to outdated or missing sensor data).

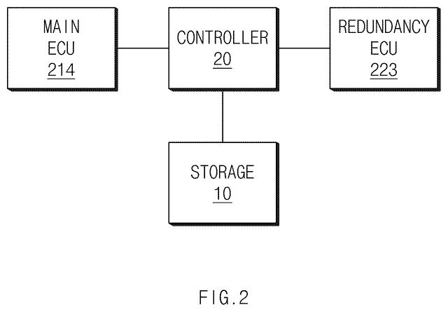

FIG. 2 shows an example of a configuration of an apparatus for controlling braking of an autonomous vehicle according to an example of the present disclosure (e.g., showing connections between processor, storage, main/redundancy control circuits, and vehicle network interfaces.

As shown in FIG. 2, an apparatus for controlling braking of an autonomous vehicle according to an example of the present disclosure may include storage 10 and the controller 20. In this case, depending on a scheme of implementing an apparatus for controlling braking of an autonomous vehicle according to an example of the present disclosure, components may be combined with each other to be implemented as one, or some components may be omitted (e.g., integrated into a central domain controller or distributed across multiple ECUs depending on system architecture.

Regarding each component, first, the storage 10 may store various logic, algorithms and programs required in the process of monitoring a state of the main ECU 214 that controls a main brake system and a state of the redundancy ECU 223 that controls a redundancy brake system in the autonomous vehicle including the main brake system and the redundancy brake system, and transferring braking control authority of the autonomous vehicle from the main ECU 214 to the redundancy ECU 223 if a failure occurs in the main ECU 214 (e.g., due to loss of power, internal malfunction, or loss of communication with the vehicle network).

The storage 10 may store various logic, algorithms and programs required in the process of monitoring the state of the main ECU 214 that controls a main brake system and the state of the redundancy ECU 223 that controls a redundancy brake system in the autonomous vehicle including the main brake system and the redundancy brake system, and transferring the braking control authority of the autonomous vehicle from the main ECU 214 to the redundancy ECU 223 if power supplied to the main ECU is interrupted or if CAN communication with the main ECU is interrupted (e.g., due to connector disconnection, wiring fault, or message timeout).

The storage 10 may store various logic, algorithms, and programs required in the process of monitoring the state of the main ECU 214 that controls a main brake system and the state of the redundancy ECU 223 that controls a redundancy brake system in the autonomous vehicle including the main brake system and the redundancy brake system, and maintaining the braking control authority of the main ECU 214 and performing a minimum risk maneuver (MRM) that applies different deceleration patterns depending on a driving environment of the autonomous vehicle if a failure occurs in the redundancy ECU 223 (e.g., to safely decelerate the vehicle in tunnels, intersections, curved highway exits, or low-grip conditions such as rain or snow, etc.).

The storage 10 may store various logic, algorithms and programs required in the process of monitoring the state of the main ECU 214 that controls a main brake system and the state of the redundancy ECU 223 that controls a redundancy brake system in the autonomous vehicle including the main brake system and the redundancy brake system, and maintaining the braking control authority of the main ECU 214 and performing the MRM that applies different deceleration patterns depending on a driving environment of the autonomous vehicle if power supplied to the redundancy ECU 223 is interrupted or if CAN communication with the redundancy ECU 223 is interrupted (e.g., due to voltage drop, CAN transceiver error, or external interference).

The controller 20 may be electrically connected to each component and may perform overall control such that each component performs its function. The controller 20 may be implemented in the form of hardware or software, or may be implemented in a combination of hardware and software. Preferably, the controller 20 may be implemented as a microprocessor, but is not limited thereto (e.g., it may also be implemented using an FPGA, ASIC, or multicore embedded processor depending on system requirements).

In particular, the controller 20 may monitor the state of the main ECU 214, which is a lower level controller, and the state of the redundancy ECU 223 from a third-party standpoint, so that it is possible to accurately detect whether the main ECU 214 is faulty or whether the redundancy ECU 223 is faulty (e.g., through signal validation, health monitoring, or watchdog timer inputs).

The controller 20 may monitor the state of the main ECU 214 and the state of the redundancy ECU 223, and if a failure occurs in the main ECU 214, may transfer the braking control authority of the autonomous vehicle from the main ECU 214 to the redundancy ECU 223. In this case, the controller 20 may determine that a failure occurs in the main ECU 214 if the power supplied to the main ECU 214 is interrupted or if the CAN communication with the main ECU 214 is interrupted (e.g., caused by a power rail fault, broken wire harness, or unresponsive CAN message cycle).

The controller 20 may monitor the state of the main ECU 214 and the state of the redundancy ECU 223, and if a failure occurs in the redundancy ECU 223, may maintain the braking control authority of the autonomous vehicle held by the main ECU 214, and perform the MRM that applies a different deceleration pattern depending on the driving environment of the autonomous vehicle (e.g., urban stop-and-go traffic, highway cruising, tunnel entry, or curved off-ramps). In this case, the router ECU 230 may determine that a failure occurs in the redundancy ECU 223 if the power supplied to the redundancy ECU 223 is interrupted or if the CAN communication with the redundancy ECU 223 is interrupted (e.g., due to electrical disconnection, wiring short, or bus signal loss).

The controller 20 may periodically transmit a standby command to the redundancy ECU 223 in a normal state. In this case, if the standby command periodically received from the controller 20 is interrupted, the redundancy ECU 223 may determine that a failure occurs in the controller 20 and may control the braking of the autonomous vehicle (e.g., by activating internal fallback logic or switching to autonomous braking control). For example, the redundancy ECU 223 has the braking control authority of the autonomous vehicle. In this case, the main ECU 214 that has the braking control authority of the autonomous vehicle is automatically deactivated because a failure occurs in the controller 20 and vehicle information may not be received from the controller 20 (e.g., such as deceleration commands, sensor fusion inputs, or CAN messages routed through the controller).

If a failure occurs in the controller 20, the controller 20 may transmit a message with a failure code recorded to the redundancy ECU 223. In this case, if the redundancy ECU 223 receives the message with a fault code recorded from the controller 20, the redundancy ECU 223 may determine that a fault has occurred in the controller 20 and may control the braking of the autonomous vehicle (e.g., by taking over brake signal generation or activating predefined deceleration curves). For example, the redundancy ECU 223 has the braking control authority of the autonomous vehicle. In this case, the main ECU 214 that has the braking control authority of the autonomous vehicle is automatically deactivated because a failure occurs in the controller 20 and vehicle information may not be received from the controller 20 (e.g., including vehicle speed, driver override status, or routing data from other vehicle systems).

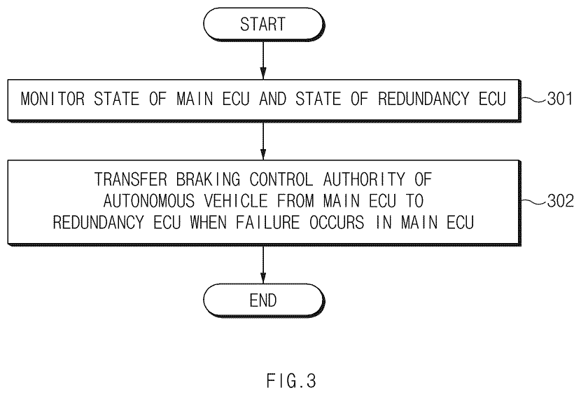

FIG. 3 shows an example of a method of controlling braking of an autonomous vehicle according to an example of the present disclosure (e.g., including stages for fault detection, control authority transition, or minimum risk maneuver execution).

First, in 301, the controller 20 monitors the state of the main ECU 214 that controls the main brake system and the state of the redundancy ECU 223 that controls the redundancy brake system. In this case, the controller 20 may monitor the state of the main ECU 214, which is a lower level controller, and the state of the redundancy ECU 223 from a third-party standpoint, so that it is possible to accurately detect whether the main ECU 214 is faulty or whether the redundancy ECU 223 is faulty (e.g., through diagnostic feedback, communication status checks, or voltage monitoring, etc.).

Next, if a failure occurs in the main ECU 214, in 302, the controller 20 transfers the braking control authority of the autonomous vehicle from the main ECU to the redundancy ECU (e.g., by activating backup control logic, re-routing actuator commands, or disabling main ECU influence on the brake system).

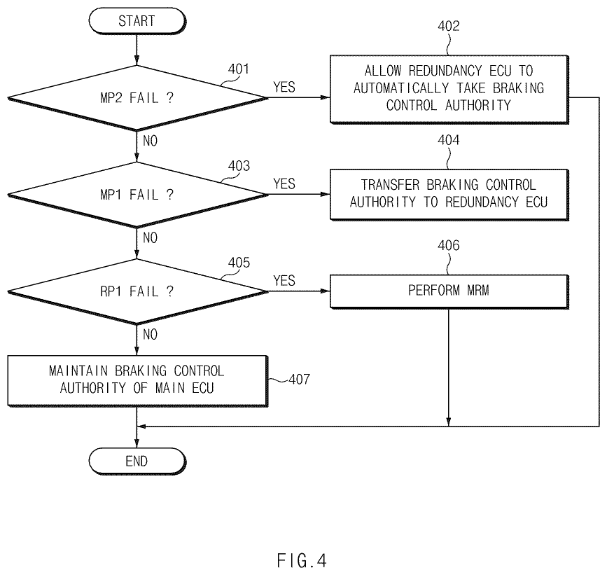

FIG. 4 shows a first detailed example of a method of controlling braking of an autonomous vehicle according to an example of the present disclosure (e.g., including power failure paths, ECU status checks, and authority transition conditions).

First, in 402, if power MP2 supplied to the router ECU 230 is cut off (YES of 401), the main ECU 214 is automatically deactivated because the main ECU 214 does not receive vehicle information from the router ECU 230, and also, the standby command received periodically from the router ECU 230 is stopped, so the redundancy ECU 223 determines that a failure occurs in the router ECU 230 and controls the braking of the autonomous vehicle (e.g., using default deceleration profiles or stored braking logic). That is, the redundancy ECU 223 has the braking control authority of the autonomous vehicle.

In 404, if the power MP2 is normally supplied to the router ECU 230 (NO of 401) and power MP1 supplied to the main ECU 214 is cut off (YES of 403), the router ECU 230 transfers the braking control authority of the autonomous vehicle to the redundancy ECU 223 (e.g., by issuing a transition command or activating redundancy-specific brake control logic).

If the power MP2 is normally supplied to the router ECU 230 (NO of 401), the power MP1 is normally supplied to the main ECU 214 (NO of 403), and power RP1 supplied to the redundancy ECU 223 is cut off (YES of 405), in 406, the router ECU 230 performs the MRM while maintaining the braking control authority of the main ECU 214 (e.g., applying a gradual deceleration pattern suited for safe lane departure or vehicle stop in a shoulder area).

If the power MP2 is normally supplied to the router ECU 230 (NO of 401), the power MP1 is normally supplied to the main ECU 214 (NO of 403), and the power RP1 is also normally supplied to the redundancy ECU 223 (NO of 405), the braking control authority of the main ECU 214 is maintained in 407 (e.g., allowing continued primary control during nominal operation without triggering failover logic).

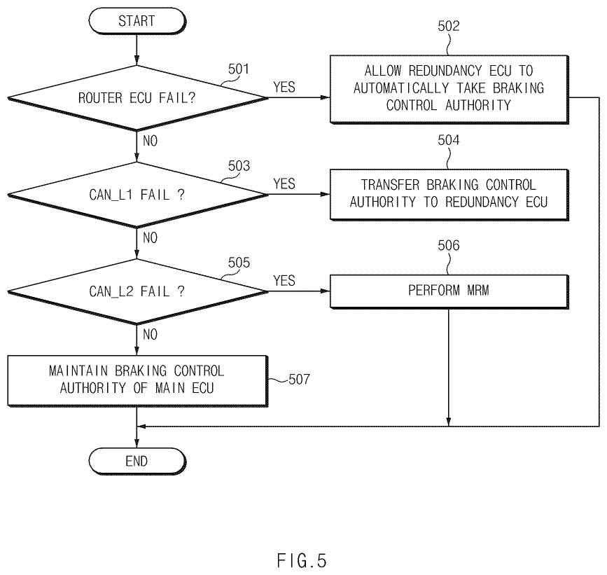

FIG. 5 shows a second detailed example of a method of controlling braking of an autonomous vehicle according to an example of the present disclosure (e.g., addressing failover logic in response to communication line failures and their impact on ECU coordination).

First, in 502, if a failure occurs in the router ECU 230 (YES of 501), the main ECU 214 is automatically deactivated because the main ECU 214 does not receive vehicle information from the router ECU 230, and also, the standby command received periodically from the router ECU 230 is stopped, so the redundancy ECU 223 determines that a failure occurs in the router ECU 230 and controls the braking of the autonomous vehicle (e.g., by engaging predefined emergency deceleration or autonomous fallback strategies). For example, the redundancy ECU 223 has the braking control authority of the autonomous vehicle.

If the router ECU 230 operates normally (NO of 501) and a failure occurs in a CAN communication line CAN_L1 of the main ECU 214 (YES of 503), in 504, the router ECU 230 transfers the braking control authority of the autonomous vehicle to the redundancy ECU 223 (e.g., through internal command signaling or network-based authority reassignment).

If the router ECU 230 operates normally (NO of 501), the CAN communication line CAN_L1 of the main ECU 214 operates normally (NO of 503), and a failure occurs in the CAN communication line CAN_L2 of the redundancy ECU 223 (YES of 505), in 506, the router ECU 230 performs the MRM while maintaining the braking control of the main ECU 214 (e.g., implementing a safe stop maneuver using predefined deceleration thresholds tailored to current traffic or road geometry).

If the router ECU 230 operates normally (NO of 501), the CAN communication line CAN_L1 of the main ECU 214 operates normally (NO of 503), and the CAN communication line CAN_L2 of the redundancy ECU 223 also operates normally (NO of 505), the braking control authority of the main ECU 214 is maintained in 507 (e.g., reflecting normal vehicle control conditions with no detected failures).

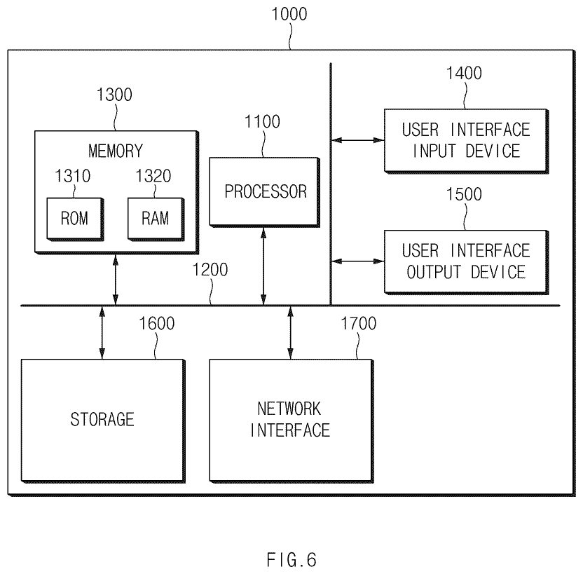

FIG. 6 shows an exemplary computing system for executing a method of controlling braking of an autonomous vehicle according to each example of the present disclosure (e.g., integrating control, monitoring, and communication functions for autonomous brake management).

Referring to FIG. 6, as described above, the method of controlling braking of an autonomous vehicle according to an example of the present disclosure may be implemented through a computing system 1000. The computing system 1000 may include at least one processor 1100, a memory 1300, a user interface input device 1400, a user interface output device 1500, storage 1600, and a network interface 1700, which are connected through a system bus 1200 (e.g., a high-speed internal communication backbone such as PCIe or AMBA interconnect).

The processor 1100 may be a central processing unit (CPU) or a semiconductor device that processes instructions stored in the memory 1300 and/or the storage 1600. The memory 1300 and the storage 1600 may include various volatile or nonvolatile storage media (e.g., DRAM, SRAM, NAND flash, or NVMe SSD). For example, the memory 1300 may include a read only memory (ROM) 1310 and a random access memory (RAM) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM (e.g., for embedded firmware, system configuration data, or runtime brake control logic). The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal (e.g., vehicle central gateway, domain controller, or onboard diagnostics module, etc.). In another method, the processor 1100 and the storage medium may reside in the user terminal as an individual component (e.g., on a dedicated control board or safety microcontroller).

One example of the present disclosure provides an apparatus for controlling braking of an autonomous vehicle which includes a main brake system and a redundancy brake system, and a method thereof capable of quickly transferring braking control authority of the autonomous vehicle without error even if a manufacturer of the main brake system is different from a manufacturer of the redundancy brake system by monitoring a state of a main electronic control unit (ECU) that controls a main brake system and a state of a redundancy ECU that controls a redundancy brake system, and transferring braking control authority of the autonomous vehicle from the main ECU to the redundancy ECU if a failure occurs in the main ECU.

Another example of the present disclosure provides an apparatus for controlling braking of an autonomous vehicle which includes a main brake system and a redundancy brake system, and a method thereof capable of quickly transferring braking control authority of the autonomous vehicle without error even if a manufacturer of the main brake system is different from a manufacturer of the redundancy brake system by monitoring a state of a main ECU that controls a main brake system and a state of a redundancy ECU that controls a redundancy brake system, and transferring braking control authority of the autonomous vehicle from the main ECU to the redundancy ECU if power supplied to the main ECU is interrupted or if controller area network (CAN) communication with the main ECU is interrupted.

Still another example of the present disclosure provides an apparatus for controlling braking of an autonomous vehicle which includes a main brake system and a redundancy brake system, and a method thereof capable of quickly transferring braking control authority of the autonomous vehicle without error even if a manufacturers of the main brake system is different from a manufacturer of the redundancy brake system by monitoring a state of a main ECU that controls a main brake system and a state of a redundancy ECU that controls a redundancy brake system, and maintaining the braking control authority of the main ECU and performing a minimum risk maneuver (MRM) that applies different deceleration patterns depending on a driving environment of the autonomous vehicle if a failure occurs in the redundancy ECU.

Still another example of the present disclosure provides an apparatus for controlling braking of an autonomous vehicle which includes a main brake system and a redundancy brake system, and a method thereof capable of quickly transferring braking control authority of the autonomous vehicle without error even if a manufacturers of the main brake system is different from a manufacturer of the redundancy brake system by monitoring a state of a main ECU that controls a main brake system and a state of a redundancy ECU that controls a redundancy brake system, and maintaining the braking control authority of the main ECU and performing a MRM that applies different deceleration patterns depending on a driving environment of the autonomous vehicle if power supplied to the redundancy ECU is interrupted or if CAN communication with the redundancy ECU is interrupted.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to one example of the present disclosure, an apparatus for controlling braking of an autonomous vehicle includes a main electronic control unit (ECU) that controls a main brake system, a redundancy ECU that controls a redundancy brake system, and a controller that monitors a state of the main ECU and a state of the redundancy ECU, and transfers braking control authority of the autonomous vehicle from the main ECU to the redundancy ECU if a failure occurs in the main ECU.

According to an example, the controller may perform a minimum risk maneuver (MRM) that applies different deceleration patterns depending on a driving environment of the autonomous vehicle if a failure occurs in the redundancy ECU.

According to an example, the redundancy ECU may control the braking of the autonomous vehicle if a standby command periodically received from the controller is interrupted.

According to an example, the redundancy ECU may control the braking of the autonomous vehicle if a message with a fault code is received from the controller.

According to an example, the controller may determine that the failure occurs in the main ECU if power supplied to the main ECU is interrupted.

According to an example, the controller may determine that the failure occurs in the main ECU if vehicle network communication with the main ECU is interrupted.

According to an example, the controller may determine that the failure occurs in the redundancy ECU if power supplied to the redundancy ECU is interrupted.

According to an example, the controller may determine that the failure occurs in the redundancy ECU if vehicle network communication with the redundancy ECU is interrupted.

According to an example, the main brake system may include a first pneumatic control valve (PCV) that controls an amount of air supplied to a right front wheel of the autonomous vehicle, a second PCV that controls an amount of air supplied to a left front wheel of the autonomous vehicle, a front axle PCV that distributes an amount of air between the first PCV and the second PCV, and a rear axle PCV that distributes an amount of air between a right rear wheel and a left rear wheel of the autonomous vehicle.

According to an example, the redundancy brake system may include a first pneumatic control valve (PCV) that controls an amount of air supplied to a right front wheel of the autonomous vehicle, a second PCV that controls an amount of air supplied to a left front wheel of the autonomous vehicle, and a rear axle PCV that distributes an amount of air between a right rear wheel and a left rear wheel of the autonomous vehicle.

According to another example of the present disclosure, a method of controlling braking of an autonomous vehicle includes monitoring, by a controller, a state of a main electronic control unit (ECU) that controls a main brake system and a state of a redundancy ECU that controls a redundancy brake system, and transferring, by the controller, braking control authority of the autonomous vehicle from the main ECU to the redundancy ECU if a failure occurs in the main ECU.

According to an example, the method may further include performing, by the controller, a minimum risk maneuver (MRM) that applies different deceleration patterns depending on a driving environment of the autonomous vehicle if a failure occurs in the redundancy ECU.

According to an example, the method may further include controlling, by the redundancy ECU, the braking of the autonomous vehicle if a standby command periodically received from the controller is interrupted.

According to an example, the method may further include controlling, by the redundancy ECU, the braking of the autonomous vehicle if a message with a fault code is received from the controller.

According to an example, the transferring of the braking control authority may include determining that the failure occurs in the main ECU if power supplied to the main ECU is interrupted.

According to an example, the transferring of the braking control authority may include determining that the failure occurs in the main ECU if vehicle network communication with the main ECU is interrupted.

According to an example, the performing of the MRM may include determining that the failure occurs in the redundancy ECU if power supplied to the redundancy ECU is interrupted.

According to an example, the performing of the MRM may include determining that the failure occurs in the redundancy ECU if vehicle network communication with the redundancy ECU is interrupted.

According to the examples of the present disclosure, in an autonomous vehicle including a main brake system and a redundancy brake system, the state of the main ECU that controls the main brake system and the state of the redundancy ECU that controls the redundancy brake system may be monitored, and the braking control authority of the autonomous vehicle may be transferred from the main ECU to the redundancy ECU if a failure occurs in the main ECU, so that it is possible to quickly transfer the braking control authority of the autonomous vehicle without error even if the manufacturer of the main brake system is different from the manufacturer of the redundancy brake system.

What is claimed:

1. An apparatus for controlling autonomous driving of a vehicle, the apparatus comprising:
a processor; and
a memory storing at least one instruction that, when executed by the processor communicating with the memory, is configured to cause the apparatus to:
control, using a first control circuit of the vehicle, a first brake system of the vehicle;
control, using a second control circuit of the vehicle, a second brake system of the vehicle;
determine a state of the first control circuit and a state of the second control circuit;
output, based on the determined state of the first control circuit and the determined state of the second control circuit, a signal indicating transfer of braking control authority of the autonomous driving of the vehicle from the first control circuit to the second control circuit; and
transfer, based on the signal, the braking control authority from the first control circuit to the second control circuit.

2. The apparatus of claim 1, wherein the at least one instruction, when executed by the processor communicating with the memory, is configured to cause the apparatus to perform, based on a failure occurring in the second control circuit, a minimum risk maneuver (MRM) associated with autonomous driving of the vehicle, wherein different deceleration patterns are applied, via the performance of the MRM, based on a driving environment of the vehicle.

3. The apparatus of claim 1, wherein the at least one instruction, when executed by the processor communicating with the memory, is configured to cause the apparatus to control, using the second control circuit and based on a periodic standby command of the apparatus being interrupted, braking operation of the autonomous driving of the vehicle.

4. The apparatus of claim 1, wherein the at least one instruction, when executed by the processor communicating with the memory, is configured to cause the apparatus to control, using the second control circuit and based on a message indicating a fault code being output by the apparatus, braking operation of the autonomous driving of the vehicle.

5. The apparatus of claim 1, wherein the at least one instruction, when executed by the processor communicating with the memory, is configured to cause the apparatus to determine, based on power supplied to the first control circuit being interrupted, that a failure occurs in the first control circuit.

6. The apparatus of claim 1, wherein the at least one instruction, when executed by the processor communicating with the memory, is configured to cause the apparatus to determine, based on vehicle network communication with the first control circuit being interrupted, that a failure occurs in the first control circuit.

7. The apparatus of claim 2, wherein the at least one instruction, when executed by the processor communicating with the memory, is configured to cause the apparatus to determine, based on power supplied to the second control circuit being interrupted, that a failure occurs in the second control circuit, and wherein the first control circuit is comprised in a first electronic control unit (ECU).

8. The apparatus of claim 2, wherein the at least one instruction, when executed by the processor communicating with the memory, is configured to cause the apparatus to determine, based on vehicle network communication with the second control circuit being interrupted, that a failure occurs in the second control circuit, wherein the second control circuit is comprised in a second electronic control unit (ECU).

9. The apparatus of claim 1, wherein the first brake system comprises:
a first pneumatic control valve (PCV) configured to control an amount of air supplied to a right front wheel of the vehicle;
a second PCV configured to control an amount of air supplied to a left front wheel of the vehicle;
a front axle PCV configured to distribute an amount of air between the first PCV and the second PCV; and
a rear axle PCV configured to distribute an amount of air between a right rear wheel and a left rear wheel of the vehicle.

10. The apparatus of claim 1, wherein the second brake system comprises:
a first pneumatic control valve (PCV) configured to control an amount of air supplied to a right front wheel of the vehicle;
a second PCV configured to control an amount of air supplied to a left front wheel of the vehicle; and
a rear axle PCV configured to distribute an amount of air between a right rear wheel and a left rear wheel of the vehicle.

11. A method performed by an apparatus for controlling autonomous driving of a vehicle, the method comprising:
determining a state of a first control circuit of the vehicle and a state of a second control circuit of the vehicle, wherein the first control circuit controls a first brake system of the vehicle, and wherein the second control circuit controls a second brake system of the vehicle;
outputting, based on the determined state of the first control circuit and the determined state of the second control circuit, a signal indicating transfer of braking control authority of the autonomous driving of the vehicle from the first control circuit to the second control circuit; and
transferring, based on the signal, the braking control authority from the first control circuit to the second control circuit.

12. The method of claim 11, further comprising:
performing, based on a failure occurring in the second control circuit, a minimum risk maneuver (MRM) associated with autonomous driving of the vehicle, wherein different deceleration patterns are applied, via the performance of the MRM, based on a driving environment of the vehicle.

13. The method of claim 11, further comprising:
controlling, using the second control circuit and based on a periodic standby command of the apparatus being interrupted, braking operation of the autonomous driving of the vehicle.

14. The method of claim 11, further comprising:
controlling, using the second control circuit and based on a message indicating a fault code being output by the apparatus, braking operation of the autonomous driving of the vehicle.

15. The method of claim 11, wherein the transferring of the braking control authority comprises determining, based on power supplied to the first control circuit being interrupted, that a failure occurs in the first control circuit.

16. The method of claim 11, wherein the transferring of the braking control authority comprises determining, based on vehicle network communication with the first control circuit being interrupted, that a failure occurs in the first control circuit.

17. The method of claim 12, wherein the performing of the MRM comprises determining, based on power supplied to the second control circuit being interrupted, that a failure occurs in the second control circuit.

18. The method of claim 12, wherein the performing of the MRM comprises determining, based on network communication with the second control circuit being interrupted, that a failure occurs in the second control circuit.

19. An apparatus of a vehicle, the apparatus comprising:
a processor; and
a memory storing at least one instruction that, when executed by the processor communicating with the memory, is configured to cause the apparatus to:
determine, based on a first state of a first brake control circuit of the vehicle and a second state of a second brake control circuit of the vehicle, that a failure has occurred in the first brake control circuit and a failure has not occurred in the second brake control circuit;
output, based on the determination, a signal indicating transferring braking control authority from the first brake control circuit to the second brake control circuit; and
control, based on the signal and using the second brake control circuit, autonomous driving of the vehicle.

20. The apparatus of claim 19, wherein:
the first brake control circuit is configured to control a first break system of the vehicle,
the second brake control circuit is configured to control a second break system of the vehicle, and
the first break system and the second break system have different braking systems.
